(19) United States
(12) Patent Application Publication
(10) Pub. No.: US 2008/0208961 A1
(43) Pub. Date: Aug. 28, 2008

(54) Parallel retrieval system

(75) Inventors: Jooyong Kim, Des Plaines, IL (US); Youngbae Oh, Chicago, IL (US); Donghyun Kim, Chicago, IL (US); Jason Michael Abate, Chicago, IL (US)

Correspondence Address: BRINKS HOFER GILSON & LIONE, P.O. BOX 10395, CHICAGO, IL, 60610, US

(73) Assignee: HOSTWAY CORPORATION

(21) Appl. No.: 11/789,020

(22) Filed: Apr. 23, 2007

Related U.S. Application Data
(60) Provisional application No. 60/903,100, filed on Feb. 23, 2007.

(51) Int. Cl. G06F 15/16

(52) U.S. Cl. 709/203

(57) ABSTRACT

In a parallel retrieval method for a web request to a particular web host from a client, a request for a target object is redirected to a best agent. The request for the target object is sent according to a designated domain name for agents instead of a domain name of the particular web host. The target object includes a first object and a second object. At the best agent, the request for the first object is associated with a domain name of a first server and the request for the second object is associated with a domain name of a second server. The request for the first object is sent to the first server and the request for the second object is sent to the second server. The client obtains in parallel, the first object from the first server and the second object from the second server.

### 1. PRIORITY

This application claims the benefit of priority of U.S. Provisional Application No. 60/903,100, filed Feb. 23, 2007. The disclosure of the above application is incorporated herein by reference.

### BACKGROUND OF THE INVENTION

1. Technical Field

This invention relates to a data retrieval system and more particularly, to a parallel retrieval system for use with a network such as the internet.

2. Related Art.

Service performance such as a response time to a client's request impacts the popularity and a continued operation of internet hosting services. For example, as a client sends a web request for movies, a server will retrieve objects for movies and respond to the client's request. The prolonged and/or delayed retrieval time may diminish and occasionally destroy the client's enjoyment of movies. Such experience may make the client frustrated and result in a termination of a particular internet hosting service.

Internet hosting service providers may operate plural servers at different geographical locations. The plural servers may contain the same content as that of a main server located at the operation facilities of internet hosting service providers. The plural servers may be referred to as reflectors, as opposed to the main server which may be referred as an origin server. The reflectors may respond to some requests from clients on behalf of the origin server. The reflectors may improve the response speed. However, it requires administrative expenses and efforts to manage the reflectors. Keeping the content of the reflectors up-to-date may require large expenditure and resources of the internet hosting service providers.

In a similar way, a content delivery network includes an origin server and cache servers that are distributed at multiple geographical locations. The content delivery network operates such that a cache server, instead of the origin server, provides a client with objects such as images. The cache server is selected mainly based on its network proximity to the client. The network proximity to the client will likely improve the response speed. For that reason, the focus of the content delivery network is directed to selecting the best cache server.

### SUMMARY

In one embodiment, a parallel retrieval method for use with an internet is provided. A client sends a web request to a virtual web host. The web request includes a request for a target object which includes a first object and a second object. The request for the target object is redirected to an agent. At the agent, a request for the first object is associated with a first server and a request for the second object is associated with a second server. The client obtains in parallel the first object from the first server and the second object from the second server.

In other embodiment, a parallel retrieval method for a web request to a particular web host from a client is provided. In the parallel retrieval method, a request for a target object is redirected to a best agent. The target object includes a first object and a second object. The request for the target object is sent according to a designated domain name for agents instead of a domain name of the particular web host. At the best agent, the request for the first object is associated with a domain name of a first server and the request for the second object is associated with a domain name of the second server. The request for the first object is sent to the first server and the request for the second object is sent to the second server. The client obtains in parallel, the first object from the first server and the second object from the second server.

In another embodiment of a parallel retrieval method, a request for a target object is redirected to a best agent according to a designated domain name for agents instead of a domain name of a particular web host. The best agent determines whether the target object can be divided into one or more sub-objects. Upon determination that the target object can be divided, the best agent divides the target object into a first sub-object and a second sub-object. The client receives a concurrent download function which enables the client to have parallel access to a first server and a second server based on returned URLs of the first sub-object and the second sub-object. The returned URL of the first sub-object includes a domain name of the first server and the returned URL of the second sub-object includes a domain name of the second server. The client obtains the first sub-object at the first server via one connection and the second object at the second server via the other connection.

In further another embodiment of a parallel retrieval method, a web page including a first and a second objects as embedded objects is requested. A request for at least the embedded objects is redirected to a first cache server and a second cache server after a client inquires a relevant name server about a plurality of internet protocol (IP) addresses corresponding to a designated domain name shared by the first and the second cache servers. The client receives the IP addresses including those of the first and the second cache servers. The first object and the second object are, in parallel, retrieved from the first cache server using the IP address of the first cache server via one connection and from the second cache server using the IP address of the second cache server via the other connection.

In further another embodiment of a parallel retrieval method, a web page including a first and a second objects as embedded objects are requested. A request for at least the embedded objects is redirected to a first cache server and a second cache server. During the redirection, the first object is assigned with a first hash value and the second object is assigned with a second hash value. The first hash value is associated with the first cache server and the second hash value is associated with the second cache server, which leads to selection of the first cache server and the second cache server among a plurality of cache servers. The request for the embedded objects is sent to the first and the second cache servers according to the assigned domain names of the first and second cache servers. While maintaining concurrent connections with a client, the first cache server and the second cache server provide to the client, in parallel, the first object via one connection and the second object via the other connection.

In further another embodiment, a parallel retrieval system for a web request to a particular web host from a client includes an origin server, a plurality of cache servers and an agent. The origin server operates to serve the particular web host. The cache servers include a first cache server and a second cache server. The first cache server supplies a first object to the client and the second cache server concurrently supplies a second object to the client. The agent receives a request for the first object and a request for the second object based on changed URLs of the first object and the second object. The changed URLs include a domain name of the agent instead of a domain name of the particular web host. The agent distributes the request for the first object to the first cache server and the request for the second object to the second cache server.

In further another embodiment, a parallel retrieval system for a web request for a particular web host from a client includes a content delivery network and a parallel retrieval mechanism. The content delivery network includes an origin server, a plurality of cache servers and an agent. The origin server operates to serve the particular web host. The cache servers include a first cache server and a second cache server. The first cache server supplies a first object to the client and the second cache server supplies a second object to the client. The agent receives the web request or requests for the first and the second objects instead of the particular web host. The parallel retrieval mechanism automates association of the first and the second objects with domain names of the first and the second cache servers. The parallel retrieval mechanism further maintains concurrent connection of the client with the agent, the origin server and the first and the second cache servers.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram illustrating one example of a content delivery network system.

FIG. 2 is a block diagram illustrating a first embodiment of a parallel retrieval system.

FIG. 3 is a flowchart illustrating operation of the parallel retrieval system of FIG. 2.

FIG. 4 is a flowchart illustrating one example of assignment of multiple domain names of cache servers in the parallel retrieval system of FIG. 2.

FIG. 5 is a block diagram illustrating a second embodiment of a parallel retrieval system.

FIG. 6 is a flowchart illustrating operation of the parallel retrieval system of FIG. 5.

FIG. 7 is a block diagram illustrating a third embodiment of a parallel retrieval system.

FIG. 8 is a block diagram illustrating a fourth embodiment of a parallel retrieval system.

FIG. 9 is a flowchart illustrating operation of the parallel retrieval system of FIG. 8.

### DETAILED DESCRIPTION OF THE PREFERRED EMBODIMENTS

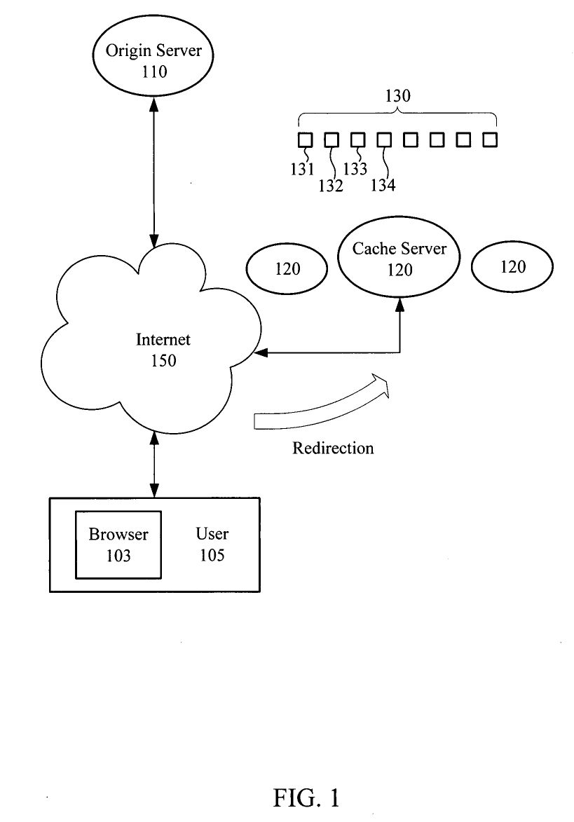

FIG. 1 is a block diagram illustrating one example of a content delivery network system 100. The content delivery network system 100 includes an origin server 110 and a cache server 120, both of which may be in communication with a user 105. The cache server 120 is one of a plurality of cache servers. The cache server 120 may be selected based on proximity to the user 105. For example, the cache server 120 is located in the same location as the user 105. The content delivery network system 100 is often used for an internet service on a global scale.

The user 105 may send a web request to the origin server 110. The web request includes a request for a target object 130. The target object 130 may include one or more embedded objects 131, 132, 133 and 134. The origin server 110 may respond to the user 105 by providing a container page including links to the embedded objects 131, 132, 133 and 134. A domain name (URL) of the embedded objects 131, 132, 133 and 134 may have been modified with a representative domain name of the cache server 120. Such modification may be made offline. Alternatively, the user 105 may receive an Internet Protocol (“IP”) address of the cache server 120 based on the location of the user 105. The user 105 sends the request to the cache server 120 and receives the requested target object 130.

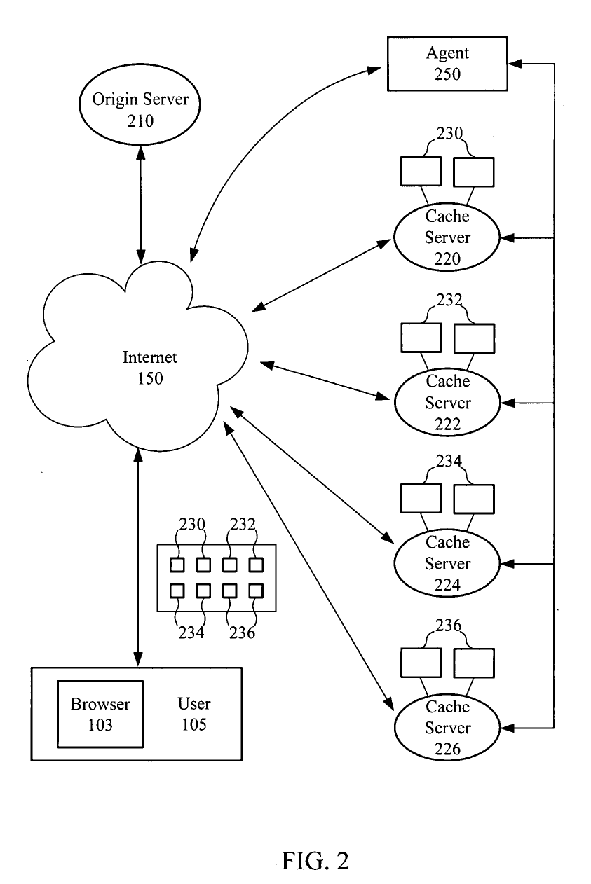

FIG. 2 is a block diagram of a first embodiment of a parallel retrieval system 200. The parallel retrieval system 200 includes an origin server 210, an agent 250 and a plurality of cache servers 220, 222, 224 and 226. In this embodiment, the agent 250 is associated with the cache servers 220, 222, 224 and 226. Four cache servers are shown in FIG. 2 only by way of example and convenience. The system 200 may be implemented with any number of cache servers. The agent 250 may or may not be geographically close to the user's location. The agent 250 may be a physical server or an application operating with a physical server. The agent 250 may be a single server or may include plural servers disposed at multiple locations. The cache servers 220, 222, 224 and 226 may include a target object. In this embodiment, the target object includes objects 230, 232, 234 and 236. For example, each object includes two image files. Alternatively, the cache servers 220, 222, 224 and 226 may have no target object. The cache servers 220, 222, 224 and 226 may pull the objects 230, 232, 234 and 236 from the origin server 210 and cache them for future use.

The agent 250 may have monitoring information on the cache servers 220, 222, 224 and 226. The agent 250 may monitor the cache servers 220, 222, 224 and 226 in real time, or alternatively, the agent 250 may receive the monitoring information from other servers which monitor the cache servers 220, 222, 224 and 226. The monitoring information includes a status of the cache servers 220, 222, 224, 226, for example, whether the cache servers are active, and/or overloaded. The monitoring information further includes mapping between the target object and the cache servers 220, 222, 224 and 226. This mapping may guide the user 105 to retrieve a particular object from a particular cache server.

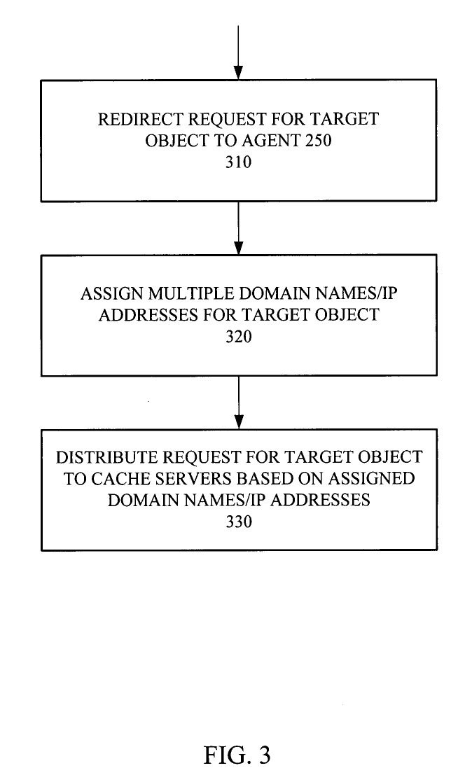

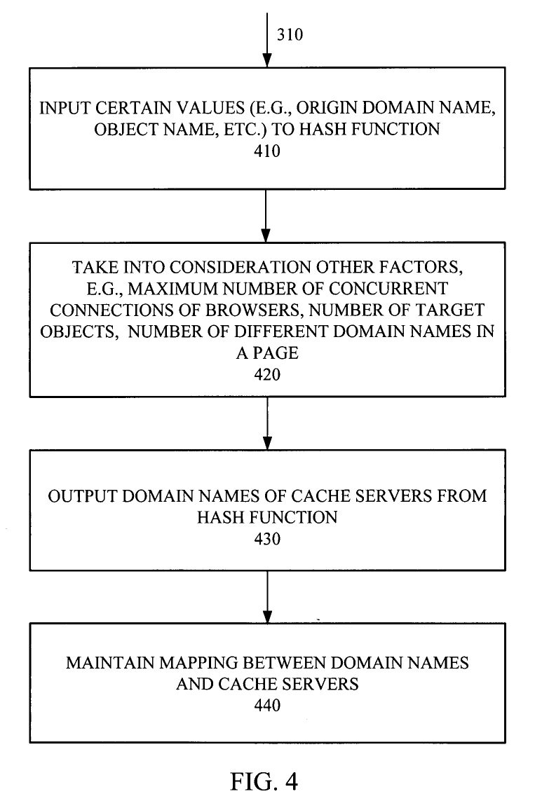

Referring to FIGS. 3-4, operation of the parallel retrieval system 200 of FIG. 2 is explained. Initially, the user 105 sends a request via the internet 150. The user 105 requests the objects 230-236, as shown in FIG. 2. The target object includes a text file, images, moving pictures, programs, etc. At block 310, the request from the user 105 is subject to redirection to the agent 250. All of the user's request may be redirected. Alternatively, the user's request may be partially redirected. For instance, when the user 105 requests a web page, the origin server 110 returns a container file to the user 105 and the user's request for embedded objects is redirected to the agent 250.

To redirect the request to the agent 250, various solutions are available. One of such solutions is a DNS redirection technique. The DNS redirection technique may modify URLs of the objects 230, 232, 234 and 236 at the origin server 110. The modified URLs include representative domain name of the agent 250. For instance, when the user 105 requests an embedded object, image1.jpg, the domain name of this embedded object is changed as follows:

<img src=http://agent.eg.edgecaching.net/images/redirected_image1.jpg>

A browser 103 requests a name server (not shown) to resolve this modified domain name. The name server will return one or more IP addresses of the agent 250. For instance, the name server may provide the IP addresses of the agent 250 which are the closest to the user 105 based on the location of the user 105. The browser 103 selects an available IP address among the returned IP addresses and sends the request to the agent 250. Alternatively, the DNS redirection may use a Canonical Name (CNAME) contained in the name server. A CNAME provides a one-to-one mapping between particular domain names. A domain name of the origin server 210 is aliased with that of the agent 250 by using a CNAME.

The redirection may be performed for a request for a container file. The container file may include embedded objects. For example, the domain name of the container file is modified to be redirected to the agent 250 with the DNS redirection as follows:

<img src=http://agent.eg.edgecaching.net/an_image_container.html>

The embedded objects of the container file may have relative URLs which shares the same domain name of the container file. The agent 250 may provide the container file to the user 105 and redirect the embedded objects to the cache servers 220, 222, 224 and 226 for the parallel retrieval. To redirect the embedded objects, the agent 250 may rewrite the URLs of the embedded objects in the container file. This may reduce a number of redirections.

Instead of the DNS redirection, an application level redirection technique may be used, such as HTTP redirection. With the HTTP redirection, the origin server 110 selects the best agent based on the user's IP address and returns to the user 105 a new URL including a domain name of the best agent. The user 105 will send a new request to the selected agent. More detailed explanation on the DNS and the application level redirections is described in U.S. application Ser. No. 11/340,167, filed Jan. 26, 2006, which is incorporated herein by reference.

As a result of the redirection, the agent 250 receives the request for the target object (at block 310) in FIG. 3. The agent 250 distributes the received request to the cache servers 220, 222, 224 and 226 (at block 330). All of the cache servers 220, 222, 224 and 226 engage in responding to the request from the user 105. The user 105 may concurrently download objects 230, 232, 234 and 236 from the cache servers 220, 222, 224 and 226 with the parallel access.

For the parallel access, the agent 250 associates the target object with the cache servers 220, 222, 224 and 226. In FIG. 3, the agent 250 assigns multiple domain names or IP addresses of the cache servers 220, 222, 224 and 226 for the target object (at block 320). In this embodiment, the HTTP redirection is used to associate the target object with the cache servers 220, 222, 224 and 226. In other embodiments, various solutions such as URL rewriting are available, as will be described below. As the target object is associated with the cache servers 220, 222, 224 and 226, the agent 250 distributes the request for the target object to the cache severs 220, 222, 224 and 226 based on the assigned domain names or IP addresses (at block 330).

FIG. 4 illustrates one example of the association between the target object and the cache servers 220, 222, 224 and 226 using the HTTP redirection. In this embodiment, a hash function is used to achieve the HTTP redirection. By way of example, the target object includes eight (8) image files. After the DNS redirection to the agent 250 (block 310), URLs of the eight image files, upon receipt by the agent 250, have been changed as follows:

agent.eg.edgecaching.net/images/redir_image1.jpg

agent.eg.edgecaching.net/images/redir_image2.jpg

agent.eg.edgecaching.net/images/redir_image3.jpg

agent.eg.edgecaching.net/images/redir_image4.jpg

agent.eg.edgecaching.net/images/redir_image5.jpg

agent.eg.edgecaching.net/images/redir_image6.jpg

agent.eg.edgecaching.net/images/redir_image7.jpg

agent.eg.edgecaching.net/images/redir_image8.jpg

The URLs of the image files include an origin domain name (“eg” as a key identifying the origin domain name), object name (image1.jpg) and an origin path name (/images/ . . . ) and etc. As previously described, the HTTP redirection returns a new domain name or an IP address of a cache server to the user 105. The agent 250 performs a hash function to produce the domain names of the cache servers 220, 222, 224 and 226 for the target object, which in turn will be returned to the user 105. As shown in FIG. 4, a certain factors are input to the hash function (at block 410). In this embodiment, the factors include the URLs of the objects 230, 232, 234 and 236. As noted above, the URLs of the objects 230, 232, 234 and 236 include the origin domain names, the object names and the origin path names. The hash function transforms the URLs of the objects into the URLs including the domain names of the cache servers. A hash value may be calculated for an URL of the object. The hash value is representative of an URL of the cache server. If two hashes are different, two inputs are different in some way. The hash function provides the same hash value for two identical inputs. Additionally, the size of the objects 230, 232, 234 and 236 may be input to the hash function. The hash function may produce outputs that designate a particular server depending on the size of the object.

In addition to the factors which are input to the hash function, other factors may be considered for the parallel retrieval (at block 420). A maximum number of concurrent connections of the browser 103, a number of embedded objects in a page, a number of total target objects, and a number of different domain names in a page may be considered for associating the target object with the cache servers 220, 222, 224 and 226. The hash function inputs noted above may be represented by certain values. Estimated values may be used for the hash function inputs instead of unknown values.

By using the example shown above and FIG. 2, the agent 250 distributes the request for the eight embedded objects to four different cache servers 220, 222, 224 and 226. The browser 103 may maintain two connections per virtual web host in accordance to the relevant protocol, HTTP/1.1. The browser 103 may maintain two connections with the agent 250. By way of example, the browser 103 sequentially sends requests for image files, image1.jpg and image2.jpg, image3.jpg and image4.jpg via one connection. The browser 103 also sequentially sends requests for the remaining image files, image5.jpg, image6.jpg, image7.jpg and image8.jpg via the other connection. The agent 250 sequentially receives these requests and distributes them to the cache servers 220, 222, 224 and 226.

There may be a limit as to a maximum number of concurrent connections that the browser 103 opens. Specific number of the concurrent connections may vary depending on specifications of the browser 103. If the maximum number of concurrent connections is twelve (12), the browser 103 may communicate with four virtual web hosts concurrently with the two connections pursuant to HTTP/1.1. The browser 103 may maintain connections with the origin server 210 and/or the agent 250. For this reason, four domain names may be assigned for the parallel retrieval of the user's request. After the distribution by the agent 250, the browser 103 receives four domain names of the cache servers 220, 222, 224 and 226 as will be shown in Table 1 below. By way of example, the browser 103 may concurrently send requests for two image files, image1.jpg and image5.jpg with two connections to the cache server 220. Likewise, the browser 103 may concurrently send requests for image2.jpg, image6.jpg to the cache server 222, requests for image3.jpg, image7.jpg to the cache server 224 and requests for image4.jpg and image8.jpg to the cache server 226. The cache servers 220, 222, 224 and 226 may concurrently respond to the requests. As a result, the browser 103 may concurrently download eight images files in parallel from the four cache servers 220, 222, 224 and 226.

The domain name and the cache servers 220, 222, 224 and 226 may have a one-to-one mapping. In other words, one cache server has a domain name which is different from the other cache server. Alternatively, a single physical cache server may have two or more different domain names. The single physical server may have two or more virtual web hosts. Two or more virtual web hosts are identified with different domain names. As a result, two or more virtual web hosts resident on the single physical server may respond to the user's request in parallel. In other embodiment, multiple physical servers may use a single domain name.

The hash function produces an output in response to the URLs of the target object available at the agent 250 (at block 430). By way of example, the cache servers 220, 222, 224 and 226 may be mapped to the URLs of the target object through the hash function as follows (at block 430 and block 440):

TABLE 1
Hash Function Mapping Table

| HASH FUNCTION INPUT | HASH FUNCTION OUTPUT |
|---|---|
| agent.eg.edgecaching.net/images/redir_image1.jpg | cache1.eg.edgecaching.net/images/redir image1.jpg |
| agent.eg.edgecaching.net/images/redir_image2.jpg | cache2.eg.edgecaching.net/images/redir image2.jpg |
| agent.eg.edgecaching.net/images/redir_image3.jpg | cache3.eg.edgecaching.net/images/redir image3.jpg |
| agent.eg.edgecaching.net/images/redir_image4.jpg | cache4.eg.edgecaching.net/images/redir image4.jpg |
| agent.eg.edgecaching.net/images/redir_image5.jpg | cache1.eg.edgecaching.net/images/redir image5.jpg |
| agent.eg.edgecaching.net/images/redir_image6.jpg | cache2.eg.edgecaching.net/images/redir image6.jpg |
| agent.eg.edgecaching.net/images/redir_image7.jpg | cache3.eg.edgecaching.net/images/redir image7.jpg |
| agent.eg.edgecaching.net/images/redir_image8.jpg | cache4.eg.edgecaching.net/images/redir image8.jpg |

The agent 250 may contain a hash table that generates the mapping between the URLs of the target object and the URLs including the domain names of the cache servers 220, 222, 224 and 226. To optimize the browser caching effect, particular objects are preferably routinely associated with domain names of the particular cache servers.

In this embodiment, the parallel retrieval mechanism for use with the parallel retrieval system 200 includes the HTTP redirection which employs the hash function. Namely, the HTTP redirection is used to associate the target object with the cache servers 220, 222, 224 and 226, and the hash function produces hash values representative of the domain names of the cache servers 220, 222, 224 and 226 in response to URLs of the objects 230, 232, 234 and 235. As exemplified with the HTTP redirection using the hash function, the parallel retrieval mechanism automates association of requested the target object and the cache servers. The parallel retrieval mechanism is not limited to the hash function and any solution which automates such association between the target object and the cache servers is available. In other embodiment, the parallel retrieval mechanism may include an URL rewriting. The agent 250 may rewrite the URLs of the objects 230, 232, 234 and 235. The URL rewriting technique is particularly useful when a container page is redirected to the agent 250. The agent 250 may respond to the user with a container page including rewritten links to the objects 230, 232, 234 and 235.

In another embodiment, the parallel retrieval mechanism may not include the application redirection such as the HTTP redirection and the URL rewriting techniques noted above. In further another embodiment, the parallel retrieval mechanism may focus on conditions of the cache serves. Accordingly, the agent 250 may distribute the request for the objects 230, 232, 234 and 236 to the cache servers 220, 222, 224 and 226, for example, based on the cache servers' load. Alternatively, the parallel retrieval mechanism may try to minimize processing burden on the agent 250. The agent 250 may distribute the request in a round-robin manner, or even randomly. In further another embodiment, the parallel retrieval mechanism may be tailored to storage space saving and an improved memory hit rate. The agent 250 may be aware of a precise location of a particular object in a particular cache server and immediately distribute a request for that particular object to the particular cache server.

The parallel retrieval system 200 may achieve an improved performance. The parallel retrieval system 200 may maximize bandwidth usage between the browser 103 and the cache servers 220, 222, 224 and 246. With a serial retrieval, a browser and any web server process requests serially. A browser may be able to send a new request to a web server only after a browser fully retrieves the response of a previous request. In the meantime, the bandwidth between a browser and a web server is in an idle status. On the other hand, the parallel retrieval system 200 may enable the browser 103 to retrieve objects from other connections. This may reduce an occurrence of the bandwidth idleness and shorten a data retrieval time such as a page loading time.

The parallel retrieval system 200 may save disk space of the cache servers 220, 222, 224 and 226 and increase a memory hit rate at the cache servers 220, 222, 224 and 226. For instance, a particular image file may be exclusively stored in a particular cache server. This would maximize space utilization and upgrade a memory hit rate.

As shown in the above table, the agent 250 automatically distributes the requests. The automatic distribution by the agent 250 may reduce administrative tasks and overhead expenses. The agent 250 also may simplify the URL modification process and improve the accuracy of the URL modification process, particularly in connection with the parallel retrieval of the embedded objects.

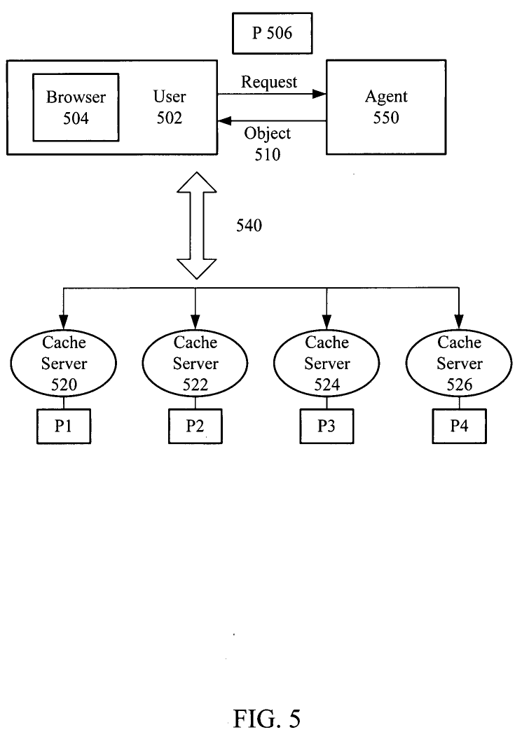

FIG. 5 is a block diagram illustrating a second embodiment of a parallel retrieval system 500. The parallel retrieval system 500 communicates with a user 502 which sends a request for a target object P 506. In this embodiment, the target object P 506 may be relatively large in size, for example, 4 MB. Alternatively, or additionally, the target object P 506 may be customized dynamic objects, for example, objects in grid computing. The target object P 506 may include calculation that requires large processing capacity, such as finding prime numbers between 1 and 1,000,000. The target object P 506 may be suitable for being divided into multiple sub-objects. Although an origin server is not shown in FIG. 5, the parallel retrieval system 500 includes an origin server which may initially respond to the user's request. There is a plurality of cache servers 520, 522, 524 and 526. Each cache server may include (push), or pull from the origin server, objects such as P1, P2, P3 and P4. As described in conjunction with FIG. 2 above, the request from the user 502 may be redirected to an agent 550 with the DNS redirection technique, or the application level redirection technique. The user 502 sends the request for the target object P 506 to the agent 550 as a result of the redirection.

In response to the user's request, the agent 550 returns to the user 502 a modified object 510. The modified object may include a software application. The software application may include a code, a script, and/or a program. The software application may be proprietary. Alternatively, the software application may be prepared with, for instance, a Asynchronous JavaScript and XML (“AJAX”) program, a flash file player, etc. The AJAX program may be used to retrieve a large-sized object. The user's browser 504 receives and runs the modified object 510.

The modified object 510 may include a certain function that enables the browser 504 to have parallel access to the cache servers 520, 522, 524 and 526. For instance, the modified object 510 is a proprietary program of an internet hosting service provider. When the browser 504 runs the proprietary program, domain names of the cache servers 520, 522, 524 and 526 may be revealed. The browser 504 subsequently sends requests to the cache servers 520, 522, 524 and 526.

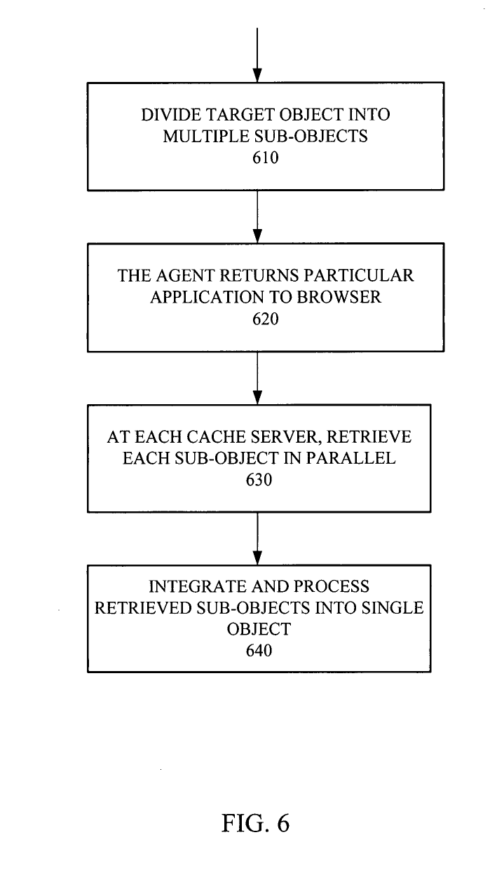

FIG. 6 is a flowchart illustrating operation of the parallel retrieval system 500 of FIG. 5. The target object P 506 is divided into multiple sub-objects P1-P4 by the agent 550 at block 610. The agent 550 may determine whether it is desirable or necessary to divide the target object P 506. The target object P 506 may be divided into multiple ranges by the agent 550. Alternatively, or additionally, the target object P 506 may be divided into small sub-objects having small size. For instance, a target object of 4 MB may be divided into four small sub-objects of 1 MB. Upon dividing the target object P 506, the agent 550 may take into account factors such as cache server capacity, or dynamic load of the cache servers. As noted in conjunction with FIG. 2, the agent 550 may have load monitoring information of the cache servers 520, 522, 524 and 526.

At block 620, the agent 550 returns the proprietary software application to the browser 504. The browser 504 runs the application. The browser 504 may send a partial GET request to the cache servers 520, 522, 524 and 526. By using the above example, i.e., the target object of 4 MB, the cache servers 520, 522, 524 and 526 may receive a partial GET request for each sub-object of 1 MB. Each cache server 520, 522, 524 or 526 may retrieve a sub-object of 1 MB in parallel (at block 630). At block 640, the browser 504 receives each sub-object of 1 MB from the four cache servers 520, 522, 524 and 526 and processes them to be integrated into a single object. Accordingly, the browser 504 may retrieve the large-size target object P 506 in parallel from the plural cache servers 520,522, 524 and 526.

The agent 550 may generate a flash file player that retrieves multiple sub-objects of the target object P 505. Alternatively, the flash file player file may be retrieved by the agent 550 from the origin server. In response to the user's redirected request, the agent 550 may return the generated or the adjusted flash file player to the browser 504. The browser 504 obtains the player, which in turn may retrieve the multiple sub-objects divided from the target object P 505 from the cache servers 520, 522, 524 and 525. Preferably, the parallel retrieval system 500 is used for the retrieval of the single target object P 505, but it is not limited thereto.

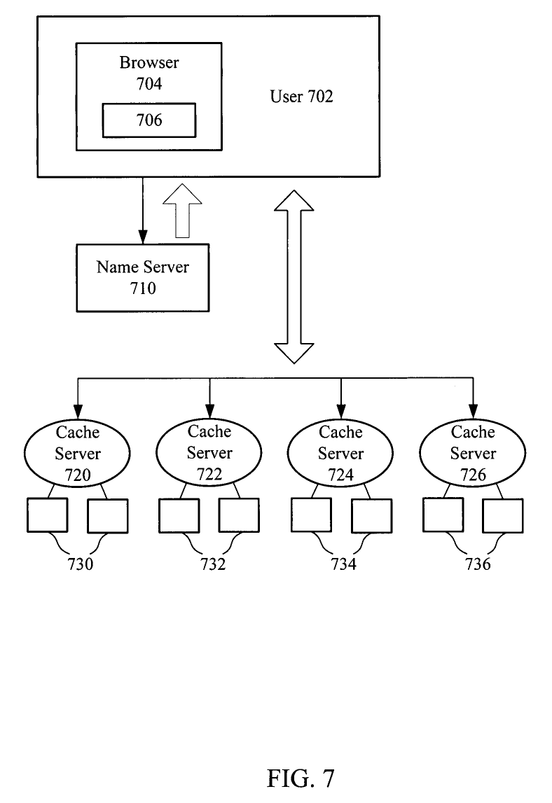

FIG. 7 is a block diagram illustrating a third embodiment of a parallel retrieval system 700. The parallel retrieval system 700 communicates with a user 702, a name server 710 and a plurality of cache servers 720, 722, 724 and 726. The user 702 sends a request for a target object. In this embodiment, the target object includes plural objects 730, 732, 734 and 736. In other embodiments, each of the objects 730, 732, 734 and 736 may be the sub-object of a single object.

Unlike the previously described embodiments, the parallel retrieval system 700 has no agent. Alternatively, the parallel retrieval system 200 may include an agent. The user's request would be redirected to the cache servers 720, 722, 724 and 726. The browser 704 inquires a name server 710 about IP addresses mapped to a representative cache server domain. The name server 710 may monitor potential cache servers including the cache servers 720, 722, 724 and 726 and check whether each cache server is fully functional. Additionally, the name server 710 may further monitor other information of the cache servers, such as overload status, update status, location relative to the user 702, etc.

In response to the inquiry from the browser 704, the name server 710 returns multiple IP addresses of the cache servers 720, 722, 724 and 726. The browser 704 may include a parallel function module 706 that enables the user 702 to have parallel access to the cache servers 720, 722, 724 and 726. The parallel function module 706 may select several IP addresses among the returned multiple IP addresses rather than a single IP address. The parallel function module 706 may include a parallel download function of plural objects or multiple sub-objects of a single object. As the several IP addresses are selected, the browser 704 sends parallel requests to the cache servers 720, 722, 724 and 726. With the parallel function module 706, the browser 704 is able to receive the objects 730, 732, 734 and 736 in parallel. The maximum number of concurrent connections of the browser 704 may be fully utilized. The bandwidth usage between the browser 704 and the cache servers 720, 722, 724 and 726 may be optimized.

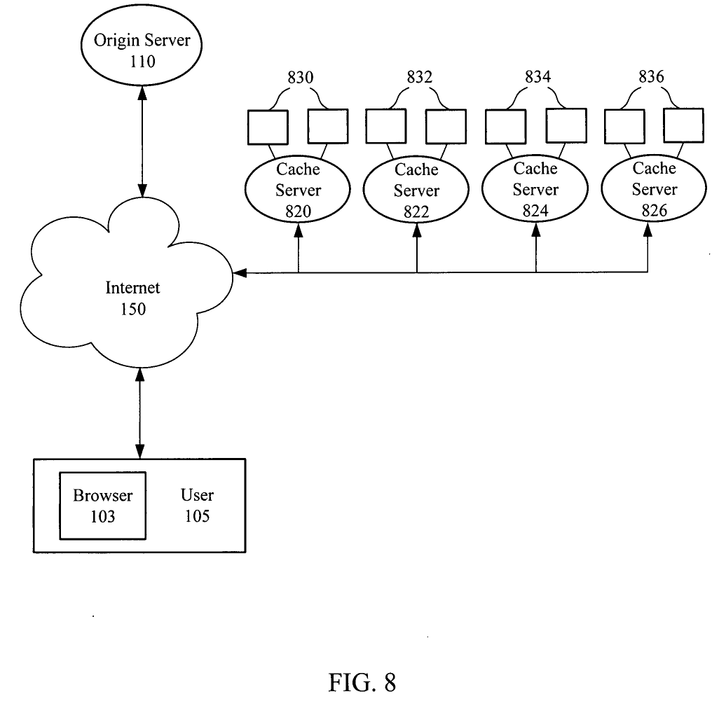

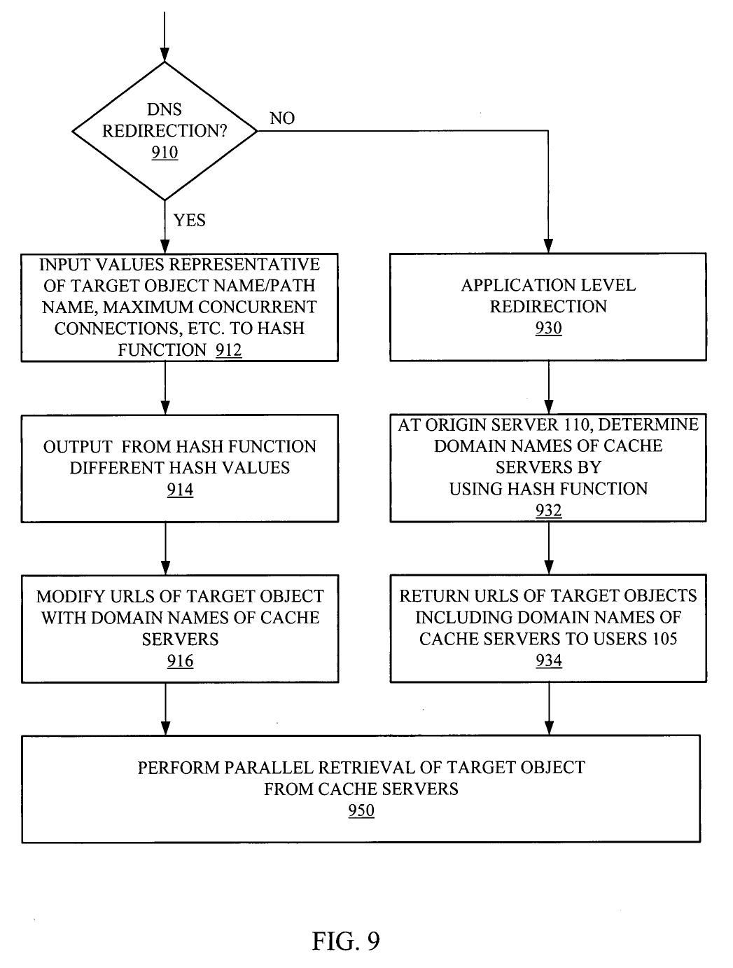

FIG. 8 is a block diagram illustrating a fourth embodiment of a parallel retrieval system 800 and FIG. 9 is a flowchart illustrating operation of the parallel retrieval system 900. In FIG. 8, the parallel retrieval system 800 includes the origin server 110 and a plurality of cache servers 820, 822, 824 and 826. The user 105 sends a request for a target object to the parallel retrieval system 800. In this embodiment, the target object includes objects 830, 832, 834 and 836. The user 105's request is redirected to the plurality of cache servers 820, 822, 824 and 826. The parallel retrieval system 800 includes no agent. The cache servers 820, 822, 824 and 826 may include objects 830, 832, 834 and/or 836. Alternatively, the cache servers 820, 822, 824 and 826 may pull the objects 830, 832, 834 and/or 836 from other servers such as the origin server 110.

The parallel retrieval system 800 redirects the request of user 105 to the cache servers 820, 822, 824 and 826. The user 105 has parallel access to the cache servers 820, 822, 824 and 826 and retrieves the objects 830, 832, 834 and 836 in parallel. For the parallel retrieval, URLs of the objects may be associated with different domain names of the cache servers 820, 822, 824 and 826.

Referring to FIG. 9, a detailed explanation on operation of the parallel retrieval system 800 of FIG. 8 is provided. The redirection techniques to the cache servers 820, 822, 824 and 826 may include the DNS redirection or the application level redirection. The redirection performing in this embodiment consolidates two acts: one act is to redirect the request to the cache servers 820, 822, 824 and 826, and the other act is to associate the requests for the objects 830, 832, 834 and 836 with domain names of the cache servers 820, 822, 824 and 826. As a result of the redirection, the user 105 would be guided to send the request for the objects 830, 832, 834 and 836 to the cache servers 820, 822, 824 and 826.

With the DNS redirection at block 910, the parallel retrieval system 800 may use a hash function to associate the target object and the cache servers 820, 822, 824 and 826 (at block 912 and block 914). The original URLs of the target object are input to the hash function (at block 912) and the domain names of the cache servers 820, 822, 824 and 826 may be output from the hash function (at block 914). In some cases, a domain name shared by a plurality of cache servers including the cache servers 820, 822, 824 and 826 may not be designated yet. In those cases, the hash function input may include an object name and an object path name. The URLs of the objects would be associated with different hash values. Subsequently, the shared domain names of cache servers may be determined, for example, as a one-to-one mapping through a CNAME. For instance, in response to a request for a certain web page, the origin server 110 would return an html page to the user 105. The web page includes five embedded objects. When the browser 103 receives the html page, the URLs of the five embedded objects may have already reflected five different hash function outputs based on object names and object name paths of the five embedded objects. The browser 103 parses the received html page and determines the URLs of the embedded objects. When the browser 103 inquires about IP addresses relating to the URLs of the embedded objects, a name server may choose such IP addresses based on the proximity to the user. Subsequently, the browser sends requests for the five embedded objects to the plurality of cache servers. The domain names shared by the cache servers 820, 822, 824 and 826 would be determined at the time that the browser 103 sends the request for the five embedded objects.

Additionally, many factors, such as type of objects, size of objects, a maximum number of concurrent connections of the browser, a number of embedded objects in a web page, a number of total target objects, and a number of different domain names in a web page, may be considered, as described in detail in conjunction with FIG. 4 above (block 912 and block 950). The hash input factors described above may be represented or indicated in certain values. When precise values are not known, estimated values may be used instead.

After the target object and the cache servers 820, 822, 824 and 826 are paired with the hash function (at block 912 and block 914), the URLs of the target object are modified with the domain names of the cache servers 820, 822, 824 and 826 based on the output of the hash function at block 916. This modification may be performed at the origin server 110 via offline (block 916). For instance, this modification to the URLs of the objects in web pages may be done manually or with proprietary tools. Alternatively, or additionally, the modification may be performed at the time of requesting the object. Subsequently, the modified URLs are returned to the user 105 and the user 105 sends requests to the plural cache servers 820, 822, 824 and 826. The user 105 has parallel access to the objects 830, 832, 834 and 836 (at block 950).

With the application level redirection (at block 930), the hash function is also used to associate the target object with the cache servers 820, 822, 824 and 826 (at block 932). For instance, the origin server uses the HTTP redirection to redirect the request to the cache servers 820, 822, 824 and 826 (at 932). The origin server 110 may determine the user's location based on the IP address of the user 105. The domain names of the cache servers 820, 822, 824 and 826 are assigned for the target object with the hash function (at block 932). Instead of the target object, the origin server 110 returns a new URL including the domain names of the cache servers 820, 822, 824 and 826 to the user 105 (at block 934). The user 105 sends requests to the cache servers 820, 822, 824 and 826 and has parallel access to the objects 830, 832, 834 and 836.

The embodiments described above of the parallel retrieval system includes the parallel retrieval mechanism that automates the association between objects and cache servers. The agent may perform the parallel retrieval mechanism. Alternatively, the user's browser may perform the parallel retrieval mechanism, either individually, or in combination with the agent. The association between objects and cache servers may be performed with various solutions. Various solutions include the application level redirection such as the HTTP redirection implemented with the hash function, and the URL rewriting technique, the round-robin distribution, the random distribution, and/or object-cache server storage mapping. In particular, the user would have parallel access to the plurality of cache servers with multiple concurrent connections. The user would retrieve one object from one server via one connection and a different object from a different server via the other connection.

The embodiments of the parallel retrieval system described above may achieve an improved performance including an improve response time, load balancing and storage capacity saving. The embodiments of the parallel retrieval system may reduce administrative tasks and expenses and automate URL change processes. The embodiments of the parallel retrieval system may optimize the bandwidth utilization between the browser and the cache severs.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A parallel retrieval method for a web request to a particular web host from a client, comprising:
redirecting to a best agent a request for a target object which comprises a first object and a second object, the redirecting comprising sending the request for the target object according to a designated domain name for agents instead of a domain name of the particular web host;
at the best agent, associating the request for the first object with a domain name of a first server and the request for the second object with a domain name of a second server; and
returning to the client in parallel the first object from the first server and the second object from the second server in response to the request for the first object to the first server and the request for the second object to the second server.

2. The parallel retrieval method of claim 1, further comprising selecting the best agent among the agents based on the location of the client.

3. The parallel retrieval method of claim 1, wherein returning to the client in parallel comprises supplying the first object via one connection and supplying the second object via the other connection.

4. The parallel retrieval method of claim 1, wherein the associating comprises:
calculating a first hash value representative of the domain name of the first server in response to a hash function input of a uniform resource locator (URL) of the first object; and
calculating a second hash value representative of the domain name of the second server in response to the hash function input of the URL the second object.

5. The parallel retrieval method of claim 1, further comprising:
maintaining concurrent connections with the best agent, the first server and the second server;
in response to a request for a web page including the first object and the second object as embedded objects, returning to the client the domain name of the first server from the best agent via a first connection with the best agent and returning to the client the domain name of the second server via the first connection or a second connection with the best agent.

6. The parallel retrieval method of claim 5, wherein the associating comprises:
calculating a hash value representative of the domain name of the first server in response to a hash function input, the hash function input comprising a uniform resource locator (URL) of the first object, a maximum number of concurrent connections including connections of the client with the best agent and the first and the second servers, a number of the embedded objects in the web page, a number of different domain names used in the web page, a number of the embedded objects, or a combination thereof.

7. The parallel retrieval method of claim 6, wherein the calculating the hash value comprises calculating the hash value representative of the domain name of the first server based on an estimated value of the hash function input.

8. The parallel retrieval method of claim 1, further comprising:
receiving and responding to the request for the first object at a first virtual web host which operates as the first server and includes a first domain name; and
receiving and responding to the request for the second object at a second virtual web host which operates as the second server and includes a second domain name.

9. The parallel retrieval method of claim 8, further comprising operating a physical web server where the first virtual web host and the second virtual web host are resident.

10. A parallel retrieval method for a web request to a particular web host from a client, comprising:
redirecting to a best agent a request for a target object, the redirecting comprising sending the request for the target object according to a designated domain name for agents instead of a domain name of the particular web host;
at the best agent, determining whether the target object can be divided into one or more sub-objects;
upon determination that the target object can be divided into the one or more sub-objects, dividing the target object into a first sub-object and a second sub-object;
returning to the client a concurrent download function which enables the client to have parallel access to a first server and a second server based on returned URLs of the first sub-object and the second sub-object, a returned URL of the first sub-object including a domain name of the first server and a returned URL of the second sub-object including a domain name of the second server; and
obtaining the first sub-object from the first server via one connection and the second object from the second server via the other connection.

11. A parallel retrieval method, comprising:
requesting a web page including a first object and a second object as embedded objects;
redirecting to a first cache server and a second cache server a request for at least the embedded objects, the redirecting comprising inquiring about a plurality of internet protocol (IP) addresses corresponding to a designated domain name shared by the first cache server and the second cache server; and,
returning to a client the plurality of IP addresses comprising those of the first cache server and the second cache server;
retrieving in parallel the first object from the first cache server using an IP address of the first cache server and the second object from the second cache server using an IP address of the second cache server.

12. A parallel retrieval method, comprising:
receiving a request for a web page including a first object and a second object as embedded objects;
redirecting to a first cache server and a second cache server a request for at least the embedded objects, the redirecting comprising:
assigning a first hash value for the first object and a second hash value for the second object;
associating the first hash value with the first cache server and the second hash value with the second cache server and selecting the first cache server and the second cache server among a plurality of cache servers;
receiving the request for the embedded objects at the first and the second cache servers while maintaining concurrent connections with a client; and
returning to the client the first object from the first cache server via one connection and returning to the client the second object from the second cache server via the other connection, wherein the client obtains the first object and the second object in parallel.

13. The parallel retrieval method of claim 12, wherein the assigning comprises:
calculating the first hash value with a hash function input of the first object to a hash function; and
calculating the second hash value with a hash function input of the second object to the hash function;
wherein the hash function input comprises an object name and an object path name.

14. The parallel retrieval method of claim 13, wherein the assigning further comprises inputting to the hash function, a value indicative of a maximum number of concurrent connections at the client including connections at the client with the first and the second cache servers, a number of the embedded objects in the web page, a number of different domain names used in the web page, or a combination thereof, wherein the hash function calculates the first hash value and the second hash value further based on the value.

15. A parallel retrieval system for a web request to a particular web host from a client, comprising:
an origin server operable to serve the particular web host;
a plurality of cache servers comprising a first cache server and a second cache server, the first cache server supplying a first object to the client and the second cache server concurrently supplying a second object to the client; and
an agent which receives a request for the first object and a request for the second object based on changed URLs of the first object and the second object, the agent distributing the request for the first object to the first cache server and the request for the second object to the second cache server, wherein the changed URLs include a domain name of the agent instead of a domain name of the particular web host.

16. The parallel retrieval system of claim 15, wherein the first and the second objects are objects embedded in a web page and the first and the second cache servers substantially concurrently return to the client the first and the second objects corresponding to the requested web page.

17. The parallel retrieval system of claim 15, wherein while maintaining concurrent connection of the client with the agent and the first and the second cache servers, the first cache server returns to the client the first object via one connection and the second cache server returns to the client the second object via the other connection.

18. The parallel retrieval system of claim 15, wherein the first cache server comprises a first virtual web host having a first domain name and the second cache server comprises a second virtual web host having a second domain name, the first virtual web host and the second virtual web host residing on a single physical web server.

19. A parallel retrieval system for a web request to a particular web host from a client, comprising:
a content delivery network comprising:
an origin server operable to serve the particular web host;
a plurality of cache servers comprising a first cache server and a second cache server, the first cache server supplying a first object to the client and the second cache server concurrently supplying a second object to the client; and,
an agent receiving the web request or requests for the first and the second objects redirected from the particular web host; and,
a parallel retrieval mechanism that automates association of the first and the second objects with the first and the second cache servers and that maintains concurrent connection of the client with the agent, the origin server and the first and the second cache servers.

20. The parallel retrieval system of claim 19, wherein the parallel retrieval mechanism comprises a hash function that receives an input representative of an estimated value for URLs of the first and the second objects and the hash function produces an output representative of the domain names of the first and the second cache servers.

21. The parallel retrieval system of claim 19, wherein the parallel retrieval mechanism associates the first and the second objects with the first and the second cache servers with a Hypertext Transfer Protocol (HTTP) redirection and the HTTP redirection is implemented with a hash function to produce different domain names of the first and the second cache servers.

22. The parallel retrieval system of claim 19, wherein the parallel retrieval mechanism associates the first and the second objects with the first and the second cache servers with a URL rewriting and the agent rewrites URLs of the first and the second objects to include domain names of the first and the second cache servers.

23. A parallel retrieval system for a web request to a particular web host from a client, comprising:
a content delivery network comprising:
an origin server operable to serve the particular web host;
a plurality of cache servers comprising a first cache server and a second cache server, the first cache server supplying a first object to the client and the second cache server concurrently supplying a second object to the client; and,
a parallel retrieval mechanism that redirects a request for the first and the second objects to the cache servers and automates association of the first and the second objects with the first and the second cache servers, where the redirection of the request for the first and the second objects and the association of the first and the second objects are performed substantially simultaneously.
